(19) United States
(12) Patent Application Publication
(10) Pub. No.: US 2026/0202833 A1
(43) Pub. Date: Jul. 16, 2026

(54) Method for Processing Semifinished Products, Processing Device, Computer Program, and Computer-Readable Storage Medium

(71) Applicant: Bayerische Motoren Werke Aktiengesellschaft, Muenchen (DE)

(72) Inventors: Ingo HEINLE, Inzell (DE); Tom Janis KRAUSE, Muenchen (DE); Christian SCHELSKE, Marklkofen (DE)

(21) Appl. No.: 19/134,890

(22) PCT Filed: Jan. 11, 2024
(86) PCT No.: PCT/EP2024/050518

§ 371 Date: Jun. 2, 2025

(30) Foreign Application Priority Data
Jan. 20, 2023 (DE) 10 2023 101 427.7

(51) Int. Cl. G05B 19/418

(52) U.S. Cl. CPC G05B 19/41875; G05B 2219/32194

(57) ABSTRACT

A method for processing semifinished products includes subjecting a first semifinished product to a respective processing procedure in which the first semifinished product is processed (step SI); subjecting the first semifinished product to a preassessment which is carried out prior to the processing procedure, and determining a first property value characterizing a semifinished product property of the first semifinished product (step S2); subjecting the first semifinished product to a post-evaluation which is carried out after the processing procedure, and determining a second property value which characterizes a processing property of the first semifinished product (step S3); and determining a third property value which characterizes a semifinished product property of a second semifinished product (step S4).

### BACKGROUND AND SUMMARY

The invention relates to a method for processing semifinished products. The invention also relates to a processing device for processing semifinished products. The invention also relates to a computer program. Furthermore, the invention relates to a computer-readable storage medium.

U.S. Pat. No. 9,922,345 B2 discloses a computer-implemented method. In addition, a computer-implemented method is known from U.S. Pat. No. 8,560,366 B2.

The object of the present disclosure is to provide a method, a processing device, a computer program, and a computer-readable storage medium so that particularly advantageous processing of semifinished products can be implemented.

This object may achieved according to this disclosure by a method, a processing device, a computer program, and a computer-readable storage medium having the features of the independent claim and claims depending therefrom. Advantageous embodiments of the technology are the subject matter of the dependent claims.

A first aspect of the disclosure relates to a method for processing semifinished products. For example, the respective semifinished product is a blank, in particular a sheet-metal blank, which is formed, for example, from a metallic material, in particular from sheet metal. For example, the metallic material is aluminum or steel. In the method, at least one first one of the semifinished products is subjected to at least one processing procedure, in which the first semifinished product is processed. In particular, it is provided that in the method multiple respective first ones of the semifinished products are subjected to at least one respective processing procedure. In the respective processing procedure, the respective first semifinished product which is subjected to the processing procedure is processed. In particular, the respective first semifinished product is processed by way of a processing device. The processing device can be or comprise, for example, at least one press or can be or comprise at least one press line, wherein the press line has multiple presses, by way of which, for example, the respective semifinished product is in particular successively processed. For example, the respective first semifinished product is formed during the processing, in particular deep-drawn and/or cut, in particular stamped.

In the method, the at least one first semifinished product is subjected to a preassessment, which is carried out before the processing procedure, wherein during the preassessment at least one first property value is determined for the first semifinished product, which characterizes at least one semifinished product property of the first semifinished product. In particular, the respective first semifinished product is subjected to a respective preassessment. The preassessment is carried out, for example, by way of an electronic computing unit, by way of which the method is carried out, for example. The respective preassessment is carried out before the respective processing procedure to which the respective first semifinished product is subjected, so that the respective first semifinished product is preassessed during the preassessment before the respective first semifinished product is subjected to the processing procedure and therefore is processed during the processing procedure. In the respective preassessment, at least one respective first property value is determined for the respective first semifinished product. The respective first property value characterizes or describes at least one semifinished product property of the respective first semifinished product. It is therefore provided in particular that the first property values characterize, i.e. describe or specify, the same semifinished product property.

In the method, the first semifinished product is subjected to a postassessment, which is carried out after the processing procedure, wherein in the postassessment at least one second property value is determined for the processed first semifinished product, which characterizes at least one processing property of the processed first semifinished product. In particular, it is provided that in the method the respective first semifinished product is subjected to a respective postassessment which is carried out after the respective processing procedure, to which the respective first semifinished product is subjected. It can be seen that the preassessment is carried out before the processing procedure and the postassessment is carried out after the processing procedure. In the respective postprocessing, at least one respective second property value is determined for the respective processed first semifinished product, which characterizes at least one processing property of the respective processed first semifinished product. In particular, it is provided that the second property values specify, i.e. describe or characterize, the same processing property. In particular, for example, the processing property results from the processing procedure, therefore from carrying it out. For example, the respective postassessment is carried out by way of the electronic computing unit. It is therefore conceivable that the first property values and/or the second property values are determined by way of the electronic computing unit.

In the method, for at least one second one of the semifinished products, at least one third property value is determined, which characterizes, i.e. specifies or describes, the at least one semifinished product property of the second semifinished product. Therefore, for example, the second semifinished product is subjected to at least one assessment in which the third property value is determined for the second semifinished product. The third property value preferably characterizes the same semifinished product property which is also characterized by the first property values. In particular, the at least one assessment can be the preassessment, in particular if the second semifinished product is processed after the first preassessment, for example, by way of the processing device or by way of a further processing device. The preceding and following statements on the respective processing of the respective first semifinished product can also readily be transferred to the possible processing of the second semifinished product and vice versa. Therefore, the preceding and following statements on the first processing device can be readily transferred to the further processing device and vice versa. The determination of the third property value takes place, for example, in a or the preassessment to which the second semifinished product is subjected.

If the third property value corresponds to the first property value or if a deviation of the third property value from the first property value falls below a threshold value, depending on the second property value, at least one notification signal that is acoustically and/or optically perceptible by a person is output by way of a playback unit. Alternatively or additionally, if the third property value corresponds to the first property value or if the deviation of the third property value from the first property value falls below the threshold value, the second semifinished product is processed after the determination of the third property value in dependence on the second property value.

Alternatively or additionally, if the third property value corresponds to the first property value or if the deviation of the third property value from the first property value falls below the threshold value, a module for determining, in particular recommending, process parameters for a processing procedure for processing the second semifinished product determines the process parameters for the processing procedure for processing the second semifinished product depending on the second property value. For example, the module is a software module such as an algorithm or a part of an algorithm. The module can cause, for example, an output which comprises, for example, a display signal which is displayed, for example, on an electronic display, which is also referred to as a display screen. The display signal is optically perceptible, for example, by the person located in the surroundings of the display, by which, for example, the process parameters can be communicated, in particular recommended, to the person. The person can then set the process parameters, for example, on the processing device, so that then, for example, the second semifinished product can be processed by the processing procedure for processing the second semifinished product. In this case, the process parameters are parameters of the processing procedure for processing the second semifinished product; therefore, the process parameters describe and influence the processing procedure for processing the second semifinished product. For example, the display is a component of the playback unit, so that the surroundings of the display can be the surroundings of the playback unit.

If the deviation of the third property value from the first property value is greater than or equal to the threshold value, at least one notification signal acoustically and/or optically perceptible to a person located in the surroundings of the playback unit is thus output by way of the playback unit, in particular at or in the surroundings.

It can be seen that the second property value is taken into consideration to carry out procedures or steps of the method. If, for example, the third property value corresponds to the first property value or if the deviation of the third property value from the first property value falls below the threshold value, it is thus checked, for example, whether the second property value or the first semifinished product corresponded or corresponds after its processing to at least one or multiple quality requirements. For this purpose, for example, the second property value is compared to at least one reference value which characterizes, for example, the at least one or more quality requirements. If, for example, the second property value corresponds to the reference value or a difference between the second property value and the reference value is less than a specified or specifiable level value, for example, then the second property value or the processed first semifinished product thus corresponded or corresponds to the quality requirement. This comparison takes place, for example, in the postassessment. The postassessment subsequently stores this comparison in a database. Subsequently, for example, a preparation for the second semifinished product searches for the result of the postassessment of the second property of the first semifinished product. If the quality or the second property of the first semifinished product is correct, i.e. if the second property value corresponds to the reference value or the difference between the second property value and the reference value is less than the level value, for example, no warning is output. It is therefore then presumed that if this condition is met, the second semifinished product can also be processed without problems, since it has the same or a similar third property as the first properties of the first semifinished product. However, if the postassessment of the first semifinished product shows that the quality requirements of the produced component, thus the second property value, is not correct, and if the difference between the second property value and the reference value is thus greater than or equal to the threshold value, a warning is thus output.

In particular, the playback unit is an electrical or electronic playback unit, by way of which, for example, the notification signal is in particular output to the surroundings of the playback unit, wherein the notification signal is acoustically and/or optically perceptible by the person located in the surroundings. For example, the electronic computing unit actuates the playback unit, in particular depending on the first property value or the first property values and/or depending on the second property value or the second property values and/or depending on the third property value, in order to thus cause the output of the notification signal. For example, the second semifinished product is processed after the determination of the third property value, in particular by way of the processing device or by way of a further processing device. For example, for this purpose the electronic computing unit actuates the first processing device or the further processing device as a result in order to process the second semifinished product depending on the second property value or the second property values.

It can be seen that the method according to the disclosure enables any possible processing of the second semifinished product to be carried out in consideration of the preassessment or preassessments and in consideration of the postassessment or postassessments, i.e. in consideration of the at least one first semifinished product or the first semifinished products. By considering the first semifinished product, for example, it can be concluded whether possibly the semifinished product property of the second semifinished product could result in problems and/or an undesired result of the processing of the second semifinished product. This can be avoided, for example, in that the second semifinished product is processed after the determination of the third property value depending on the second property value or the first second property values. Alternatively or additionally, the person can be made aware by way of the notification signal that problems or an undesired result of the possible processing of the second semifinished product can possibly occur. As a result, for example, the person can carry out at least one countermeasure in order to avoid the problems or the undesired result, for example, such that the person influences or at least temporarily interrupts or avoids the possible processing of the first semifinished product. Alternatively or additionally, the module, which is, for example, a process controller or functions as a process controller, can determine the process parameters depending on the second property value or the second property values and, for example, communicate them to the person. Therefore, for example, the process controller can be informed that problems or an undesired result of the possible processing of the second semifinished product can possibly occur, whereupon the process controller can determine, in particular vary, the process parameters, for example, in such a way that such problems are avoided.

It has been shown to be particularly advantageous if at least one frequency value is determined, in particular by way of the electronic computing unit. The frequency value characterizes a number of those of the first property values which are equal to the third property value and/or have a second deviation from the third property value such that the absolute value of the second deviation is less than a threshold value, which is nonzero and is predefined or predefinable, for example. It is preferably provided here that the notification signal is output by way of the playback unit depending on the frequency value. Alternatively or additionally, depending on the frequency value, the second semifinished product is processed after the determination of the third property value. Alternatively or additionally, the module determines the process parameters depending on the frequency value. The first semifinished products can thus be taken into consideration particularly advantageously in a possible and/or planned processing of the second semifinished product.

A further embodiment is distinguished in that the first property value or the first property values and/or the second property value or the second property values and/or the third property value are detected by way of at least one sensor. The property values can thus be determined particularly precisely, so that a particularly advantageous processing of the second semifinished product can be represented. For example, the sensor provides an electrical signal in particular, which characterizes, i.e. describes or specifies, the respective property value. The electronic computing unit can receive the signal and therefore determine the respective property value. Alternatively or additionally, for example, the respective, in particular detected property value can be stored in an electrical or electronic data memory in particular, in particular an electronic computing unit. The electronic computing unit can, for example, retrieve the respective property value from the data memory and thus determine it.

In a further, particularly advantageous embodiment of the technology, it is provided that the semifinished product property comprises a wall thickness, also referred to as a wall strength and, for example, formed as a sheet-metal thickness, and/or a material from which the respective semifinished product is formed and/or an amount, also referred to as a lubricating amount or lubricant amount, of a lubricant arranged on a respective surface of the respective semifinished product and/or a roughness of the respective surface and/or an elastoplastic property of the respective semifinished product. Particularly advantageous processing of the semifinished products can thus be ensured.

In a further, particularly advantageous embodiment of the technology, it is provided that the processing property comprises a wall thickness and/or an amount of a lubricant arranged on a respective surface of the respective semifinished product and/or a roughness of the respective surface and/or an elastoplastic property of the respective semifinished product. Particularly advantageous processing of the semifinished products can be ensured in this way. Alternatively or additionally, the processing property can be or comprise at least one or more quality features, which are checked or determined after the processing of the respective semifinished product, thus, for example, after a production of the respective component. For example, the processing property can comprise a geometry of the component or of the processed semifinished product, at least one or more surface defects such as sink marks, no occurrence of cracks or constrictions, one or more properties of a lubricant, a lubricant amount, a wall thickness, elastoplastic properties, and/or a roughness.

In a further, particularly advantageous embodiment of the technology, it is provided that the second semifinished product is processed after the determination of the third property value, wherein this processing does not necessarily have to take place depending on the first property values, the second property values, and the third property value. Furthermore, it is provided that after the second semifinished product has been processed, at least one fourth property value is determined for the processed second semifinished product, which characterizes the at least one processing property of the processed second semifinished product. As a result, for example, the fourth property value can be considered for at least one or multiple following processing procedures, so that particularly advantageous processing of semifinished products can be represented.

It has proven to be particularly advantageous here if the fourth property value is stored in a data memory or in the above-mentioned data memory. The fourth property value can be accessed in a particularly advantageous manner for future processing processes in this way, so that a particularly advantageous semifinished product processing can be represented. It is therefore conceivable, for example, that at least one third semifinished product, for example, is processed depending on the fourth property value. Alternatively or additionally, for example, the notification signal can be output by way of the playback unit depending on the fourth property value.

A second aspect of the disclosure relates to a processing device for processing semifinished products, wherein the processing device is designed to carry out a method according to the first aspect of the disclosure. Advantages and advantageous embodiments of the first aspect of the disclosure are to be viewed as advantages and advantageous embodiment of the second aspect of the disclosure and vice versa.

A third aspect of the disclosure relates to a computer program comprising commands which, upon the execution of the computer program by a computer, cause it to carry out the method according to the first aspect of the disclosure. Advantages and advantageous embodiments of the first aspect and the second aspect of the disclosure are to be viewed as advantages and advantageous embodiments of the third aspect of the disclosure and vice versa.

A fourth aspect of the disclosure relates to a computer-readable storage medium comprising commands, which, upon the execution by a computer, cause it to carry out the method according to the first aspect of the disclosure. Advantages and advantageous embodiments of the first aspect, the second aspect, and the third aspect of the disclosure are to be viewed as advantages and advantageous embodiments of the fourth aspect of the disclosure and vice versa.

The technology is based in particular on the following findings and considerations: Typically a production of components such as body parts for motor vehicles, in particular passenger vehicles, in press mills is divided into multiple process steps. Initially, blanks are cut from a coil, also referred to as a winding or turn, on a coiling facility also referred to as a winding facility. Trackable stacks of blanks, which are temporarily stored before the processing in a press line, arise in this case. Processing, in particular forming and very particularly deep drawing, of the respective cut blank, which is formed as an at least essentially flat plate, generally takes place in the press line. Further process steps such as trimming and/or postforming can then take place. The blanks are, for example, semifinished products formed as fine plates, which are therefore processed.

The semifinished products processed in the press mills can have variations with respect to their properties. For example, the sheet-metal thickness, the lubricant quantity, the roughness, and the elastoplastic material properties vary. Depending on the form of these variations, it can be necessary to adjust process parameters of a production process in order to achieve a required quality of the components to be produced, which are also referred to as parts. The production process is or comprises, for example, the above-mentioned processing procedure. In general, the adjustment of the process parameters, which is linked to a shutdown time of the press line, also referred to as a facility, is carried out based on experience by people who operate the facility. Depending on how long it takes to find a matching process parameter combination, significant costs can arise due to the shutdown of the facility or the production process. Typically, drawing cushion forces, a setting of drawing aids, a definition of a respective position of pathfinders, kinematics of a plunger movement, and an application of additional lubricant are used as process parameters. Furthermore, a setting of a directional apparatus on the coiling facility can also be adjusted via the process parameters.

Currently, when cutting blanks, a check is carried out with respect to observing a specification of the semifinished products. However, it is currently not possible to determine all variables which a specification of fine plates for the processing in the automobile industry comprises by way of an in-line measurement. If a violation of the specification is established, the cutting of the corresponding coil is terminated and all blanks which have been cut off from this coil are blocked for further processing. In this context, it can be particularly critical if the semifinished product property is within limits of the specification and nonetheless has not previously occurred. Such a case, which is also referred to as an indication for an intervention or intervention indication, does not necessarily have to represent a problem for the manufacturing. This also includes the case, for example, if a semifinished product meets the specification, but nonetheless is not processable. An example of this would be if the properties are scattered strongly within the limits of the specification. In principle, there is the risk of the occurrence of rejects if a required intervention is recognized too late. In such a situation, all previously known process parameter combinations are not applicable under certain circumstances and, if present, algorithms for process control cannot determine reasonable recommendations. Finding process parameters for stable further processing of such material can result in significant shutdown times. Currently, semifinished product properties, indirect and direct data for part quality and the associated intermediate products, and the process parameters of the coiling facility and press line can be recorded and assigned to a blank and a part. This assignment takes place, for example, via a series number, also referred to as a serial number, which is applied during the cutting of the blank to its respective surface, for example. These data are available in a database and can be used for an assistance system. The mentioned data are available for each individual produced part here. In principle, it would be conceivable to record the semifinished product property of the blanks (semifinished products) immediately before the processing in the press line and to apply a serial number. Even a slightly higher accuracy can be expected in the measurement of the lubricant quantity, since rearrangement processes of the lubricant could therefore also be detected during the storage of the cut blanks. However, this solution can have the disadvantage that upon the recognition of anomalies and/or a potential necessity for an intervention, hardly any time remains to react thereto. Hereinafter, a decoupling of the processing of the cutting of the blanks and the processing of the blanks is presumed, since typically more blanks are cut per unit of time than can be processed, in particular formed, later in the press line. It can occur that both processes run synchronously. However, even in this case due to the logistical processes, enough time is supposed to remain to analyze the cut blanks (semifinished products) with respect to possible required interventions. Furthermore, it is assumed, for example, that the semifinished product properties are determined during the cutting of the blanks.

Depending on the type of the analyzed semifinished product property, it can occur on the strip surface or also in the interior of the material. The roughness to describe the surface topography or the lubricant quantity, for example, are variables which relate to the surface and the elastoplastic properties and in particular to the volume of the material here. Furthermore, the sheet-metal thickness relates to the distance between the two surfaces. All of the material of a coil can have properties which indicate a required intervention here, or also only a subset thereof. The subset can be, for example, a strip in the longitudinal or transverse direction or any other limited area on one of the two surfaces or a part of the volume of the strip, wherein the surface of this volume does not have to correspond to the strip surface. If the strip is cut into smaller units, such as blanks, it is also possible to search for indications for interventions in these units.

An indication for an intervention is characterized in this context, for example, in that individual variables which describe the semifinished product properties assume values which have not yet previously occurred, or these are semifinished product properties which are not processable using the respective production process according to the data heretofore existing. It is also to be considered, for example, that semifinished products which were not processable in the past, thus could not meet the quality requirements for the produced parts or parts to be produced, may possibly become processable in the future due to changes in the production process. The opposite case can also occur that material or semifinished product, which was heretofore processable, is no longer processable due to changes in the production process. The probability of the occurrence of semifinished product properties does not represent a basis for finding indications for interventions in this context. If a low sheet-metal thickness occurs rarely, for example, but this material having this sheet-metal thickness can nonetheless be processed, this low sheet-metal thickness is not viewed as an indication for an intervention. In addition, it can be taken into account that newly occurring semifinished product properties do not necessarily have to represent a problem for the processing procedure or production process.

These can be locally constant high or low values or a course of a variable which is different in comparison to the past. The distribution of individual variables of a material can also differ in relation to the past. For example, the variance can be used to characterize such a statistical distribution. In principle, these variables are not only to be considered individually, but also as a combination. The values of these variables can also be understood as a vector. This vector is also referred to hereinafter as a vector of the semifinished product properties. Locations of similar semifinished product properties on one or more strips are points in the space of the semifinished product properties here, which have a small spacing therein. A recognition of indications for interventions can therefore be implemented in consideration of the combination of multiple variables. If present, correlations of the individual variables should also be taken into consideration in order to recognize such indications.

Analysis functions, which observe recorded semifinished product properties (properties), are currently available for planning manufacturing tasks. However, only individual coils or stacks can be analyzed. Recognizing the mentioned indications using the above-described analysis functions represents a significant challenge. To take into consideration the introduced aspects for recognizing indications, analysis functions which enable assessment running in an automated manner, which have not been available up to this point, can be advantageous. Carrying out such an assessment manually does not appear possible due to the complexity. Unjustified warnings of indications can disturb the sequence of production processes. For example, it could occur that the facility for producing parts is unjustifiably stopped in order to react to such a message. To be able to profit from a recognition of indications for interventions, only justified warnings are to be generated. This aspect also underlines the necessity of introducing an automated solution for recognizing indications. If the results of the indication identification can be stored in the long-term, it can also be analyzed, for example, which types of indications particularly affect the quality of parts. This information can be used in a next step to act in a targeted manner on optimizing the semifinished product properties.

Early recognition of indications for interventions can assist the task planning of production processes. For example, if a material critical with respect to the semifinished product properties is identified, it can be decided early whether, if present, a process controller can be used. If there is doubt that the process controller could function, it is possible to provide experts at the facility who manually take over the processing of the critical material (semifinished product). The background for this is that models for a process controller are generally trained based on data from the past. If the current semifinished product properties deviate significantly from these training data, it is to be expected that the prediction quality of the model can decrease significantly in this case. A recognition of indications for interventions can therefore assist recognizing the limits of the applicability of models for the process controller. This indication recognition also permits the responsibility to be transferred in a targeted manner to the operator from the automatic process controller. However, even without the presence of a process controller, indication recognition offers the option of assisting the preparation of production tasks. For example, it can be ensured by corresponding planning that a particularly problematic material (semifinished product) is not processed in the night shift, for example, so that experts can be on location. It is also conceivable to intensify the manual quality control in such a situation. In such a case, an additional period of time can also be planned for finding matching process parameters. The knowledge about the type of the indication can also help to derive suitable measures and therefore shorten the error search. For example, a locally lesser lubricant quantity will be reacted to more via an adjustment of the drawing aids and in the case of a globally lesser lubricant quantity, the cylinder forces of the drawing cushion will be changed more. Costs for machine shutdowns can thus be reduced. The indication recognition can also assist here in reducing the number of the rejects.

For example, it is presumed that all algorithms described hereinafter are based on data which relate to individual cut blanks (semifinished products). Both in the preassessment and also in the postassessment, a comparison of a current blank, therefore, for example, the first semifinished product, to blanks which have already been processed, therefore the second semifinished products, can take place. The current blank (first semifinished product) is, for example, the blank or the semifinished product which is about to be immediately processed. In this context, these can also be multiple blanks or multiple first semifinished products. For example, all blanks of a stack which is currently being processed or is to be processed next. The principle of the algorithms underlying the proposed method is similar independently of whether multiple blanks are to be considered simultaneously or only one single blank (semifinished product) is to be considered.

To solve the above-described technical problem, the method is proposed which, in particular automatically, carries out or performs the respective preassessment and the respective postassessment, wherein, for example, the respective preassessment and the respective postassessment form a respective overall assessment which is divided into the respective preassessment and the respective postassessment. It is determined in the scope of the preassessment, for example, whether the property, also referred to as the semifinished product property, of the blank (second semifinished product) currently about to be processed occurred in preceding production tasks, i.e. in or during the processing procedures to which the second semifinished products are subjected or were subjected. If the blank (second semifinished product), also referred to as material, has properties which have previously never occurred, a person operating the processing device or also referred to as the facility controller is thus warned, for example, in that the notification signal is output. This warning also contains a notification, for example, that with this material (second semifinished product), a problem with respect to a quality of the component to be produced (part quality) does not necessarily have to occur. Deviations are assessed in this case, for example, and classified as critical in particular if a tolerance is exceeded, in order to limit the amount of warning notifications, for example. Therefore, as introduced above, negative effects on the production process upon the occurrence of frequent warning messages are avoided.

In addition, it can be checked, for example, if the properties of the current blank (second semifinished product) already occurred in the past, to what extent these or similar semifinished product properties resulted in quality problems in the produced parts (components) in the past. In general, production processes can change during their lifecycle. For example, wear of tools can have the result that semifinished products which were processable in the past are no longer processable. Vice versa, improvements in production processes can have the result that semifinished products which were not processable in the past are processable in the future. In order to consider this aspect, for example, a chronological weighting of the assessments of the blanks which were assessed in the scope of the postassessment in the past can be carried out. Assessments (postassessments) from the more recent past are weighted more strongly here, for example. If information should exist which indicates that the semifinished product properties of the current blank (second semifinished product) could result in an infringement of quality requirements of the associated part upon processing, a warning (notification signal) is likewise output. This warning can also include a notification that this semifinished product property resulted in the past in problems with respect to maintaining the required part quality. If no information is available from the past that the semifinished product properties of the current blank could be critical, no warning is output to the facility controller and/or a status is transmitted which signals that the semifinished product properties of the current blank should not result in quality requirements not being maintained on the produced part upon its processing. This information with respect to the relationship between quality and semifinished product properties results, for example, from the postassessment of the method, which is further described hereinafter. In the scope of the postassessment, for example, it is assessed for each individual blank after completion of the manufacturing task (processing procedure) whether its semifinished product property or semifinished product properties resulted in the desired component quality. The result of this assessment (postassessment) is written in a database for the preassessment for the following manufacturing task. The result can be a Boolean variable or multiple real numbers or another string-based note. It is advantageous if this result of the assessment is linked with the serial number of the part, which was originally applied to the associated blank during the cutting.

It is described hereinafter how a similarity of the current blank (second semifinished product) with blanks which were processed in the past (first semifinished products) can be assessed. Since noise of the measurement data is also to be expected if sensors are used, it can be presumed that the probability of the occurrence of two vectors of the semifinished product properties having identical components should be very small. To be able to counter this problem or circumstance, for example, two vectors of the semifinished product properties are designated as identical even if they should be different within a certain tolerance. To implement such a tolerance, it is possible, for example, to interpret two vectors of the semifinished product properties as location vectors with respect to an arbitrary reference point and to determine a point in space of the semifinished product properties therefrom in each case. The distance between these two resulting points, which each represent the semifinished product properties of one blank, can be used as a measure of a deviation of the semifinished product properties. For example, the Euclidean distance could be used as the measure for the distance. The deviations of each individual component of the vector were weighted equally here. It is also conceivable to use other norms which enable a weighting of the difference of individual components of the vectors. One reason for this could be to take into consideration different measurement accuracies of the sensors. The tolerance introduced above therefore specifies a maximum value, for example, which the norm is permitted to adopt so that two vectors of the semifinished product properties are interpreted as identical. A tolerance can be estimated, for example, in that the difference of the vectors of adjacent blanks are determined. A limiting value for the tolerance can then be derived from the scatter of this difference. These results also permit analyzing to what extent a weighted norm is necessary. The number of the available data can also be considered in the determination of the tolerance. The more data are present, the more accurately a reasonable tolerance can be estimated. This procedure is based on the assumption that in typically running production processes of semifinished products, adjacent blanks should also have similar semifinished product properties. If adjacent blanks result from different cold strips, this pair should not be considered for the estimation of the tolerance. Finally, it can also be mentioned that the introduced norm could also be applied individually for each component of the vector of the semifinished product properties. For a final assessment of the similarity, in this case the assessment of all individual variables could be combined again to form an overall assessment. It is also to be noted that there is also the possibility of smoothing the data before the processing using the mentioned algorithm. To establish the similarity of a blank to blanks from the past, these can be compared on the basis of the application introduced above of a norm and a corresponding tolerance. The computing effort for such a comparison can be high, but possible or performable. To meet this challenge, clusters of similar blanks can be identified using typical algorithms from machine learning, and the comparison can then be reduced to representatives of a cluster. In spite of the cluster formation, individual blanks can still be observed for the comparison which cannot be assigned to one of the clusters. Alternatively or additionally, algorithms from the area of anomaly recognition can be used. It is also to be mentioned that the definition of the tolerance can also be used for the definition of the sensitivity for the generation of warnings. The higher the tolerance is selected to be, the more rarely critical blanks are recognized in the scope of the preassessment. In contrast, fewer warnings are recognized in the context of the postprocessing if the tolerance is selected as low. It can therefore be reasonable to select the tolerance differently for the preassessment and postassessment.

For the postassessment, if available, recorded data with respect to the part quality can be used. Specifically, the data of the part quality of a part are compared with the requirements. If an infringement of one or more quality criteria is established, this infringement is stored in the database based on the above-mentioned serial number. Quality criteria can in this case be, inter alia, the occurrence of cracks and/or measured geometric deviations between the part geometry and the associated desired geometry. Therefore, it can be determined for each blank from the past whether after its processing a quality problem resulted on the part (component) resulting therefrom. This information is used, for example, as the basis for the described postassessment. Alternatively or additionally, variables can be used which indirectly indicate the quality of the produced parts or descriptively describe the quality. For the last-mentioned case, one example would be that it is documented in a quality detection system that a part has or had surface defects. An interruption-free production indicates that the quality requirements for the parts were met. The quality of the production process can therefore be concluded indirectly on the basis of the analysis of the stability of the production process. The notification of an advantage or a necessity of an intervention in the production process can be used both for manual and automatic control of production processes. The method offers the advantage of recognizing the necessity early for interventions in the production process during a preparation for work. Furthermore, at least the following advantages can be implemented by the method:
ensuring the availability of experts for remedying problems if needed
assisting in the planning of the personnel for a shift (for example, intensifying visual checks for a critical material)
shortening errors search due to the available analysis of anomalies
recognizing early, if present, a required transfer from a process controller to the operator.

### BRIEF DESCRIPTION OF THE DRAWING

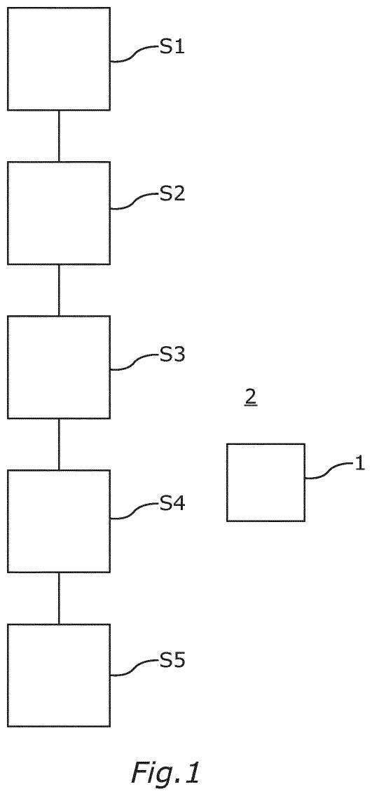

Further details of the technology result from the following description of a preferred exemplary embodiment with the associated drawing. The single FIG. 1 shows a flow chart to illustrate a method for processing semifinished products.

### DETAILED DESCRIPTION OF THE DRAWING

The single FIG. 1 shows a flow chart on the basis of which a method for processing semifinished products will be explained hereinafter. In a first step S1 of the method, respective first ones of the semifinished products are each subjected to at least one respective processing procedure. In the respective processing procedure, the respective first semifinished product which is subjected to the respective processing procedure is processed. For example, the respective first semifinished product is processed such that the respective first semifinished product is formed, in particular deep-drawn and/or trimmed, in particular stamped. The respective processing procedure is, for example, a production process or part of a production process, wherein components, which are also referred to as parts, are produced from the first semifinished products by way of the production process. In particular, the respective processing procedure is carried out by way of a processing device. The processing device is or comprises, for example, at least one press. Furthermore, it is conceivable that the processing device is or comprises a press line, which can have multiple presses, for example.

In a second step S2 of the method, the respective first semifinished product is subjected, in particular by way of an electronic computing unit, to a respective preassessment, which is carried out before the respective processing procedure. Therefore, for example, second step S2 is carried out chronologically before first step S1. In the respective preassessment, at least one respective first property value, which characterizes at least one semifinished product property of the respective first semifinished product, is determined for the respective first semifinished product before the respective first semifinished product is subjected to the respective processing procedure. In a third step S3 of the method, which follows, for example, first step S1 and second step S2, the respective first semifinished product is subjected, in particular by way of the electronic computing unit, to a respective postassessment. The respective postassessment is carried out chronologically after the respective processing procedure to which the respective first semifinished product is subjected. In the respective postassessment, at least one respective second property value is determined for the respective processed first semifinished product, which characterizes at least one processing property of the respective processed first semifinished product. The processing property can be a property different from the semifinished product property or the semifinished product property is the processing property, wherein, for example, the respective semifinished product property or its respective property value changes due to the respective processing procedure, in particular to the respective processing property or to the respective second property value.

In a fourth step S4 of the method, which in particular chronologically follows first step S1, second step S2, and third step S3, at least one third property value, which characterizes the at least one semifinished product property of the second semifinished product, is determined for at least one second one of the semifinished products, in particular by way of the electronic computing unit. In a fifth step S5 of the method, which in particular follows first step S1, second step S2, third step S3, and fourth step S4, for example, the third property value is compared with the first property value.

If the third property value corresponds to the first property value or a deviation of the third property value from the first property value falls below a threshold value, at least one notification signal acoustically and/or optically perceptible by a person is output by way of a playback unit depending on at least one of the second property values. Alternatively or additionally, if the third property value corresponds to the first property value or the deviation of the third property value from the first property value falls below the threshold value, the second semifinished product is processed after the determination of the third property value depending on the at least one second property value. Alternatively or additionally, if the third property value corresponds to the first property value or the deviation of the third property value from the first property value falls below the threshold value, the process parameters for the processing procedure for processing the second semifinished product are determined depending on the at least one second property value by way of a module for determining process parameters for a processing procedure for processing the second semifinished product.

If the deviation of the third property value from the first property value is greater than or equal to the threshold value, in a sixth step S6 of the method, at least one notification signal acoustically and/or optically perceptible by a person is output by way of the playback unit.

### LIST OF REFERENCE SIGNS

1 electronic computing unit
2 surroundings
S1 first step
S2 second step
S3 third step
S4 fourth step
S5 fifth step

1-9. (canceled)

10. A method for processing semifinished products, the method comprising:
subjecting a first semifinished product to a processing procedure, whereby the first semifinished product is processed;
subjecting the first semifinished product to a preassessment carried out before the processing procedure and determining a first property value characterizing a semifinished product property of the first semifinished product;
subjecting the first semifinished product to a post assessment carried out after the processing procedure and determining a second property value characterizing a processing property of the first semifinished product;
determining for a second semifinished product a third property value characterizing a semifinished product property of the second semifinished product; and
comparing the third property value to the first property value;
if the third property value corresponds to the first property value or a deviation of the third property value from the first property value falls below a threshold value, depending on the second property value:
outputting a notification signal acoustically and/or optically perceptible by a person; and/or
processing the second semifinished product after the determination of the third property value; and/or
determining the process parameters for the processing procedure for processing the second semifinished product; or
if the deviation of the third property value from the first property value is greater than or equal to the threshold value, outputting the notification signal acoustically and/or optically perceptible by a person.

11. The method according to claim 10, wherein a playback unit is employed to output the notification signal.

12. The method according to claim 10, wherein a module is employed to determine the process parameters for the processing procedure for processing the second semifinished product.

13. The method according to claim 10, wherein the first property value and/or the second property value and/or the third property value is/are detected by means of at least one sensor.

14. The method according to claim 10, wherein the semifinished product property comprises:
a wall thickness, and/or
a material from which the respective semifinished product is formed, and/or
an amount of a lubricant arranged on a respective surface of the respective semifinished product, and/or
a roughness of the respective surface, and/or
an elastoplastic property.

15. The method according to claim 10, wherein the processing property comprises:
a wall thickness, and/or
an amount of a lubricant arranged on a respective surface of the respective semifinished product, and/or
a roughness of the respective surface, and/or
an elastoplastic property, and/or
a geometry, and/or
at least one surface defect.

16. The method according to claim 10, further comprising:
processing the second semifinished product after the determination of the third property value, and
after processing the second semifinished product, determining a fourth property value characterizing a processing property of the second semifinished product.

17. The method according to claim 16, wherein the fourth property value is stored in a data memory.

18. A processing device for processing semifinished products configured to carry out the method according to claim 10.

19. A computer program comprising commands which, upon execution of the computer program by a computer, cause it to carry out the method according to claim 10.

20. A computer-readable storage medium comprising commands which, upon the execution by a computer, cause it to carry out the method according to claim 10.
